(19) United States
(12) Patent Application Publication
(10) Pub. No.: US 2024/0051737 A1
(43) Pub. Date: Feb. 15, 2024

(54) OUTLET VALVE FOR AN INFUSION CONTAINER, AND INFUSION CONTAINER

(71) Applicant: SWISS TEA INNOVATION AG, Olten (CH)

(72) Inventors: Joseph Alain SCHERRER, Wangen b. Olten (CH); Franco DEL BON, Aarburg (CH); Theodor WÜST, Wetzikon (CH)

(73) Assignee: SWISS TEA INNOVATION AG, Olten (CH)

(21) Appl. No.: 18/044,676

(22) PCT Filed: Sep. 2, 2021
(86) PCT No.: PCT/EP2021/074282

§ 371 Date: Mar. 9, 2023

(30) Foreign Application Priority Data
Sep. 10, 2020 (CH) 01137/20

(51) Int. Cl. B65D 85/804

(52) U.S. Cl. CPC B65D 85/8052

(57) ABSTRACT

An outlet valve (30) for an infusion container (20) for receiving a dried infusion substance and an infusion container are disclosed. The outlet valve (30) has a valve body (32) and a closure (31). The closure (31) is movable relative to the valve body (32) in an axial direction from a first position into a second position.

The present invention relates to an outlet valve for an infusion container as well as an infusion container comprising an outlet valve according to the preamble of the independent claims.

An infusion beverage is understood in connection with the present invention as any type of beverage that can be prepared, starting from a dried infusion substance, by contact with a cold or hot infusion liquid. A typical infusion beverage is tea, for example, that is prepared by brewing tea leaves or herbs with hot water.

It is known that different types of teas require a comparatively long brewing of several minutes duration to optimally develop their aroma. The contact time between the tea leaves and the brewing water must therefore be sufficiently long.

Known from EP 3 119 245 B1 is a tea preparation device and a method which allows a measured amount of a dried infusion substance to be brought in contact with an infusion liquid over a certain contact time. This is made possible by an expandable infusion container. In order to bring the infusion liquid into the container, a lid of this container is pierced with a filling needle and the infusion liquid is introduced into the container through this filling needle. For emptying the infusion container an outlet valve is provided which opens when an excess pressure is exceeded inside the infusion container. The excess pressure is achieved by compressing the container with an expressing piston.

This process is not reliably reproducible. Depending on the dried infusion substance, the infusion container is filled more or less bulging. As a result of the pressure of the expressing piston, with a high degree of filling the container is opened earlier than with a low degree of filling. Due to fluctuations in production, not all outlet valves are identical and therefore also do not open at exactly the same pressure.

It is the object of the invention to eliminate at least one or more disadvantages of the prior art. In particular, an outlet valve should be provided for an infusion container that enables a secure, simple and in particular reproducible operation.

This object is achieved by the devices defined in the independent claims. Further embodiments are obtained from the dependent claims.

An outlet valve according to the invention for an infusion container for receiving a dried infusion substance, has a valve body and a closure. The closure is movable relative to the valve body in an axial direction from a first position into a second position.

The axial direction is substantially defined by the flow direction. In the case of, for example, rotationally symmetrical outlet valves and/or infusion containers, a central axis is provided which substantially coincides with the flow direction. Even in the case of non-rotationally symmetrical configurations of the infusion container, a central axis is provided. This is substantially defined by the connection of an inlet valve and the outlet valve. A flow direction running from the inlet valve to the outlet valve is also defined by the inlet valve and the outlet valve.

The relative movability of the closure enables a simple and in particular pressure-independent opening of the outlet valve. In addition, as a result an outlet opening can be spaced apart in relation to the infusion container, which enables dispensing of the infusion beverage without dribbling.

The outlet valve closes a dispensing opening of the infusion container.

It can be provided that a sealing element, in particular a sealing lip, is arranged on the closure for sealing between the valve body and the closure.

The outlet valve can be reliably closed by the sealing lip. Both any unintentional dispensing of an infusion beverage can be prevented and also any penetration of moisture or contaminants, for example, into the interior of the infusion container.

The valve body can have a hollow-cylindrical wall. The sealing element is arranged inside this wall and in the first position of the closure abuts against an inner surface of this wall.

A substantially homogeneous surface can be provided by an inner surface on the wall on which the sealing element comes to rest. As a result of the hollow-cylindrical design of the wall, the inner surface is also configured to be substantially cylindrical. The axial position of the sealing element is therefore tolerance-insensitive.

In addition, this configuration allows easy manufacture and the use of standard parts for the sealing element such as O rings for example.

The closure can also have a hollow-cylindrical wall. This abuts against an outer surface of the wall of the valve body for guidance of the closure. In other words, a guide element is provided by the wall of the valve body on which the hollow-cylindrical wall of the closure can slide and/or can be guided.

This enables a simple and uncomplicated guidance of the individual elements onto one another, wherein this guidance can be obtained with little expenditure and low manufacturing costs.

It can be provided that a thread is arranged on the hollow-cylindrical wall of the closure. This thread is in engagement with a thread on the outer surface of the wall of the valve body.

By definition in this case, the threads are an integral component of the respective walls.

By providing threads on the one hand on the outer surface of the wall of the valve body and on the other hand inside the hollow-cylindrical wall of the closure, the axial movement of the closure relative to the valve body can be achieved by turning the valve body. In other words, a rotational movement of the valve body overall results in an axial displacement of the valve body.

The axial displacement of the closure can thus be achieved by simple, mechanical actuating elements.

For example, a radially projecting extension can be provided on the closure which can be actuated by an actuating lever.

It is also conceivable that a toothed structure is arranged on the periphery of the closure which cooperates with a corresponding counter-toothed structure on a device for preparation of an infusion beverage. In other words, a gearwheel can be arranged on this device which engages in the toothed structure on the closure. By simply turning this gearwheel, the closure can thus be turned on the thread and thus displaced entirely in the axial direction so that a dispensing opening of the infusion container is released.

The thread also ensures that in the event of an unexpected occurrence of an excess pressure inside the infusion container an independent or unintentional opening is reliably prevented by the outlet valve.

Passage openings can be provided on the closure which are arranged between the sealing element and the hollow-cylindrical wall. These passage openings can be implemented, for example, by providing webs between the hollow-cylindrical wall of the closure and the sealing element.

This enables the infusion beverage to flow out easily from the infusion container with simultaneous guidance of the closure on the valve body.

The outlet valve, in particular the closure and/or the valve body can be fabricated in an injection moulding process from plastic, in particular from a biologically degradable plastic, preferably from a bio-based plastic.

In an additional or alternative variant, it can be provided that the closure is configured to be elastically deformable. In this embodiment, the valve body also has a hollow-cylindrical wall wherein however, the sealing element in the first position of the closure abuts against an outer surface of this wall.

By providing an elastically deformable closure, a separate sealing element can be dispensed with since as a result of the elasticity of the closure, this can take over a sealing function.

In addition, the elastic deformability enables the closure to be arranged internally in the infusion container, in particular set back with respect to the base part.

As a result of this arrangement, it is possible to easily stack the infusion containers.

Since the closure is additionally movable axially from a first position into a second position, the end thereof which provides an outlet opening can be moved out from the base part by the deformation, which enables the infusion beverage to be dispensed cleanly and free from dribbling.

In this embodiment, the closure can be formed from a flexible plastic, in particular from a biologically degradable plastic, preferably from a bio-based plastic.

Material thin points can be arranged on the closure which provide passage openings after being broken open.

As a result of such a configuration, a closure can be provided which requires no further elements for sealing and is completely tight before use, i.e. can completely seal an interior of an infusion container with respect to the surroundings.

This additionally enables the closure to be manufactured in one piece, which reduces manufacturing costs.

The material thin point can be configured as a tear-off film. A tear-off film is a point in the material having a small height or thickness compared to the width. The material thin point is typically thicker than 10 μm and preferably does not exceed a thickness of 500 μm. The material thin point is in particular at most half as thick as an adjoining wall.

In this case, it is conceivable that the closure is configured to be substantially tube-shaped, wherein a part of the tube is upside down. The closure is preferably located in the region of the eversion on the hollow-cylindrical wall of the valve body or on the outer surface of this wall. This region thus forms the sealing element.

A membrane closing the closure in which the material thin points are formed can be arranged at the end of the closure.

A further aspect relates to an infusion container for receiving a dried infusion substance for preparation of an infusion beverage. The infusion container comprises a base part, a lid part and a wall part connecting the base part and the lid part. The infusion container additionally comprises an outlet valve as presently described. The outlet valve is arranged in the base part.

The arrangement of the outlet valve in the base part makes it possible to provide a base part which no longer needs to be additionally configured and/or processed in the subsequent production process.

The infusion container is preferably expandable, wherein in particular the wall part has a variable length.

On the one hand, this enables a dried infusion substance located in the infusion container to swell up, on the other hand the infusion container can be transported and stored before use with little space requirement.

With the exception of the presently described outlet valve, the infusion container can in particular be configured according to the infusion container which is described and claimed in EP 3 119 245 B1. The infusion container is therefore in particular configured for receiving an infusion liquid in a fluid-tight manner and configured to be expanded from a collapsed shape into an expanded shape by introducing infusion liquid. Alternatively to this embodiment, said container can be additionally configured with an inlet valve. The infusion container is therefore no longer pierced for filling but is filled through the inlet valve.

The presently described infusion container is in particular suitable for carrying out the method which is described and claimed in EP 3 119 245 B1. The method in particular comprises a method in which a measured amount of a dried infusion substance is brought in contact with a measured amount of an infusion liquid and the infusion beverage is thereby produced. The dried infusion substance is provided in the infusion container which is initially present in a collapsed form and is expandable into an expanded form. The infusion liquid is introduced into the infusion container. The infusion container is expanded so that the dried infusion substance in the infusion container is brought in contact with the infusion liquid for a contact time to form the infusion beverage. The infusion container is then returned at least partially into its collapsed state by compressing and in so doing the infusion beverage is expelled at least partially from the infusion container.

Preferably before the compression or as a result of the compression of the infusion container, the outlet valve is opened by the movement of the closure relative to the valve body.

The valve body can be formed as an integral component of the base part.

This facilitates and favours manufacture and reduces the number of interfaces which must be provided on the base part.

A filter sieve can be provided at the dispensing opening of the infusion container. The hollow-cylindrical wall of the valve body can be formed adjoining the filter sieve.

This makes it possible to provide the hollow-cylindrical wall as an integral component of the filter sieve. In addition, the hollow-cylindrical wall can be arranged in the alignment of a wall of the filter sieve which in turn enables easy manufacture. As a result of this arrangement, favourable flow relationships can also be created for the emergence of the infusion beverage.

In addition, the filter sieve prevents the dried infusion substance being dispensed together with the infusion beverage from the infusion container.

Alternatively it can be provided that the filter sieve is arranged on the dispensing opening of the infusion container and the hollow-cylindrical wall is formed inside the filter sieve.

In particular, when the closure is formed as an elastically deformable element, this enables the closure to rest on this hollow-cylindrical wall inside the filter sieve and thus seal the interior of the infusion container from its surroundings.

The invention is explained in detail hereinafter with reference to an exemplary embodiment by reference to schematic figures. In the figures:

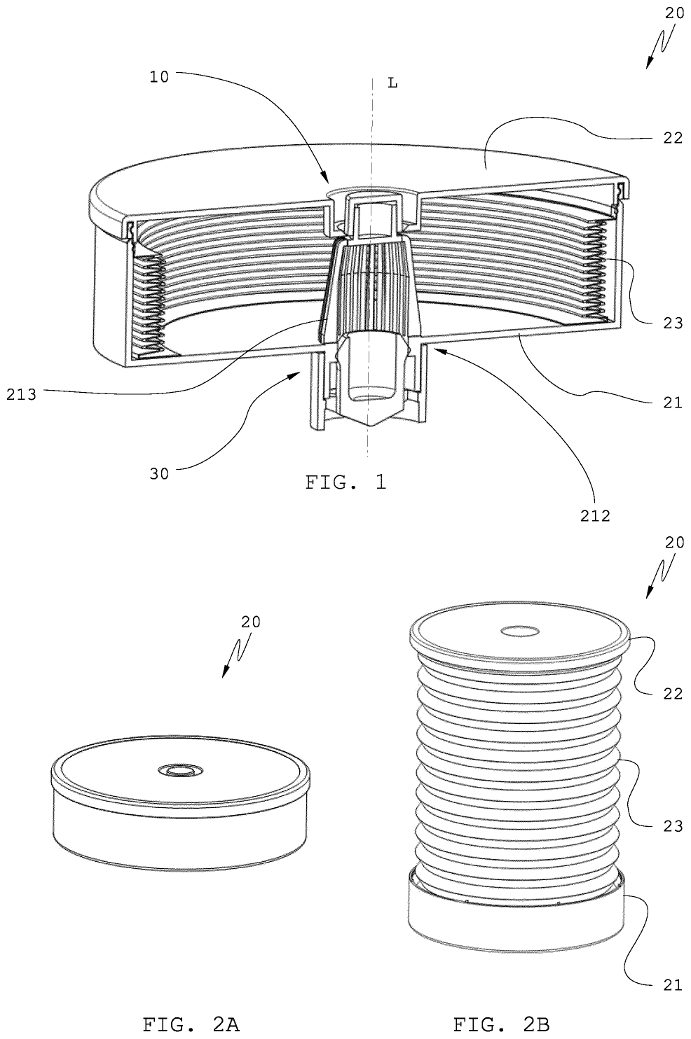

FIG. 1: shows a perspective sectional view of an infusion container;

FIG. 2A: shows a perspective view of the infusion container from FIG. 1 in a collapsed form;

FIG. 2B: shows a perspective view of the infusion container of FIG. 2A in an expanded form;

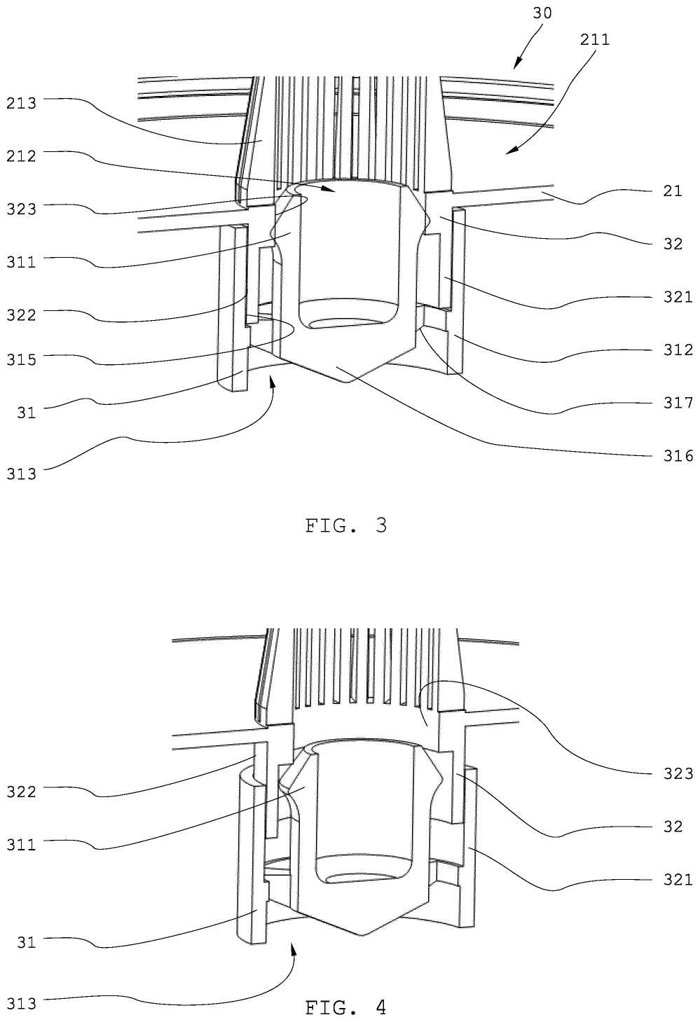

FIG. 3: shows a detailed view of the outlet valve from FIG. 1;

FIG. 4: shows a detailed view from FIG. 3 with open outlet valve;

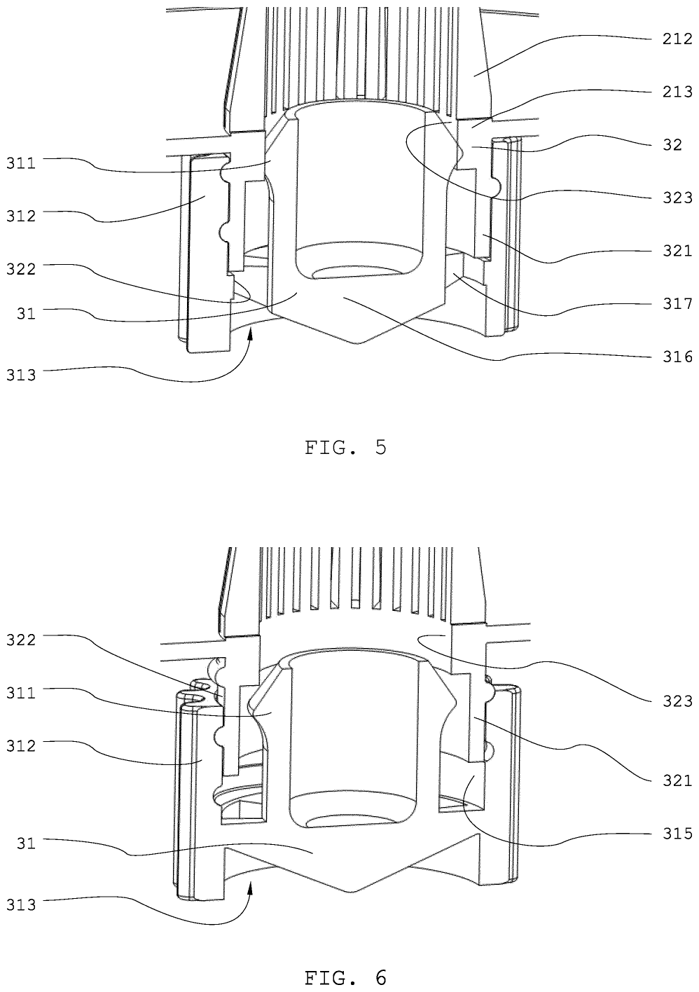

FIG. 5: shows an alternative outlet valve in a diagram according to FIG. 3;

FIG. 6: shows a detailed view from FIG. 5 with open outlet valve;

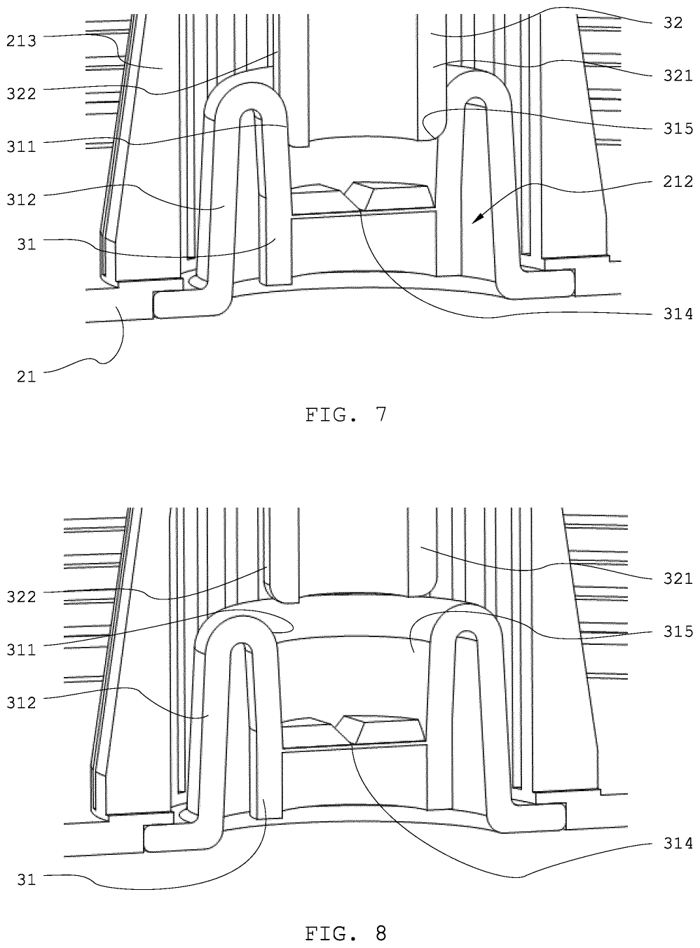

FIG. 7: shows an alternative outlet valve in a diagram according to FIG. 3;

FIG. 8: shows a detailed view from FIG. 7 with open outlet valve;

FIG. 9: shows a perspective view of an infusion container with an alternative outlet valve in a diagram according to FIG. 1;

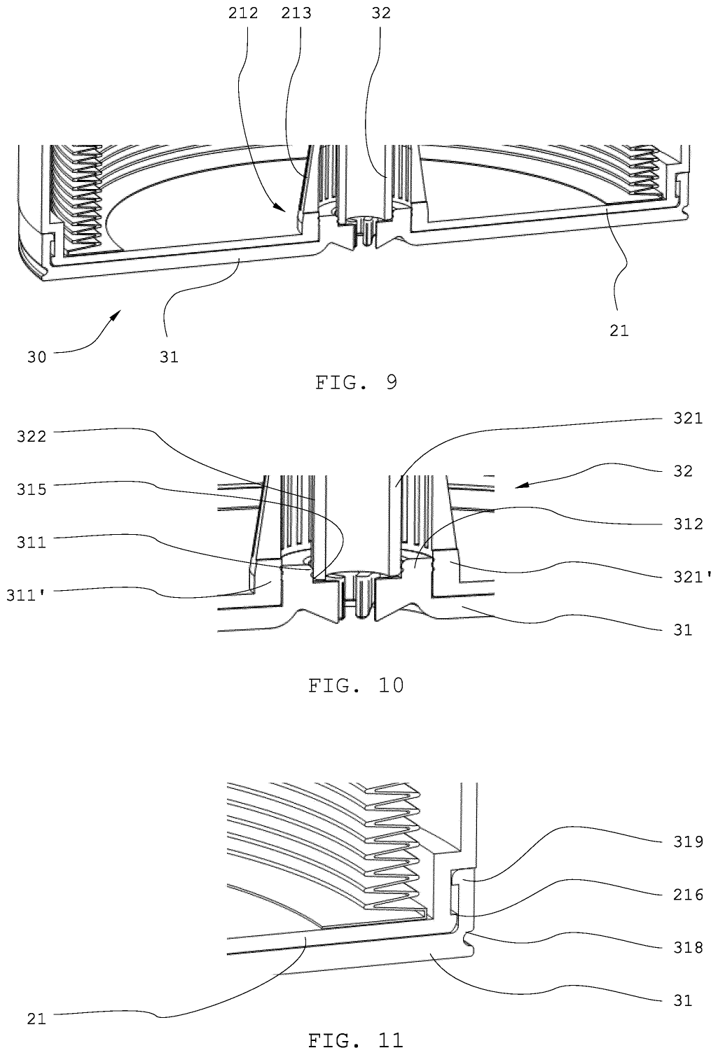

FIG. 10: shows a detailed view from FIG. 9;

FIG. 11: shows a further detailed view from FIG. 9;

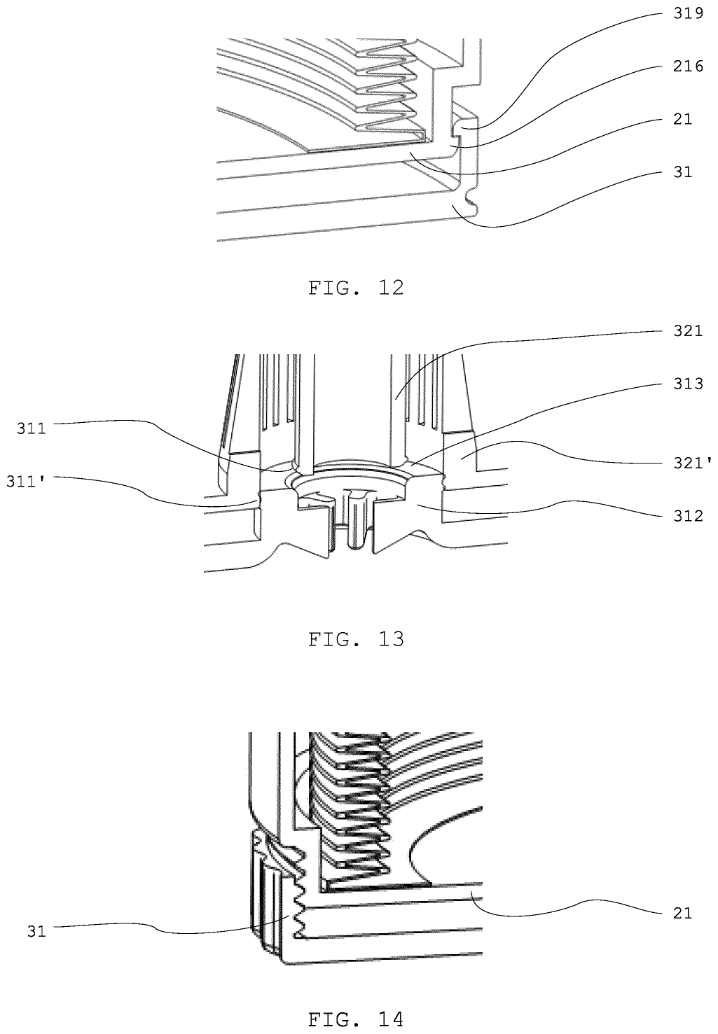

FIG. 12: shows the view according to FIG. 11 with open outlet valve;

FIG. 13: shows the view according to FIG. 10 with open outlet valve;

FIG. 14: shows a detailed view of an alternative embodiment of the outlet valve according to FIG. 9.

For the sake of better clarity in all the figures the dried infusion substance optionally located in the infusion container 20 is not shown.

FIG. 1 shows a perspective sectional view of an infusion container 20. The infusion container 20 has an inlet valve 10 and an outlet valve 30 with a dispensing opening 212. The infusion container itself comprises a base part 21, a lid part 22 and a wall part 23. The wall part 23 is expandable and in the present case is configured in the form of a bellows and fabricated from a flexible plastic. The wall part 23 is on the one hand connected in a liquid-tight manner to the base part 21 and on the other hand is connected in a liquid-tight manner to the lid part 22. This wall part 23 is enclosed by the base part 21 and by the lid part 22. To this end, a wall extending in the direction of the lid part 22 is provided on the base part 21 on the periphery thereof. As can be seen in FIG. 1, the inlet valve 10 is configured as an integral component of the lid part 22. It can also be seen that the outlet valve 30 is at least partially configured as an integral component of the base part 21. A filter sieve 213 which is arranged upstream of a dispensing opening 212 is also illustrated.

The infusion container 20 according to FIG. 1 is configured to be substantially rotationally symmetrical and has a central axis L. This also defines an axial direction. A central axis is also provided in non-rotationally symmetrical configurations of the infusion container 20. This is substantially defined by the connection of inlet valve 10 and outlet valve 30. A flow direction which runs from the inlet valve 10 to the outlet valve 30 is also defined by the inlet valve 10 and the outlet valve 30.

FIG. 2A shows a perspective view of the infusion container 20 from FIG. 1 in a collapsed form. As can be seen from FIG. 2A and from FIG. 1, in the collapsed form the base part 21 is connected to the lid part 22 via the wall arranged on the periphery thereof with corresponding break-open elements.

FIG. 2B shows a perspective view of the infusion container from FIG. 2A in an expanded form. By introducing an excess pressure via the inlet valve 10 (see FIG. 1), the break-open elements of the wall of the base part 21 are broken open and the wall part 23 expands as a result of the filling of infusion liquid into the infusion container 20. It is understood that before introducing the excess pressure, the inlet valve 10 was opened. The infusion container 20 subsequently remains in this expanded form for a predetermined time and is then compressed to expel the infusion beverage. It is understood that, as will be explained subsequently with reference to the further FIG. and 4, the outlet valve 30 (see on this matter FIG. 1) is opened in particular before the compression and the infusion beverage is dispensed through this outlet valve 30.

FIG. 3 shows a detailed view of the outlet valve 30 from FIG. 1. The outlet valve 30 has a closure 31 and a valve body 32. The valve body 32 is configured in the present case as an integral component of the base part 21. The valve body 32 has a hollow-cylindrical wall 321 which extends away from the base part 21. In other words, the hollow-cylindrical wall 321 extends in the flow direction. This hollow-cylindrical wall 321 has an outer surface 322 and an inner surface 323.

The closure 31 has a hollow-cylindrical wall 312 and a sealing element 311 arranged centrally to this wall 312. The sealing element 311 is an integral component of a cap 316 which is connected by webs 317 to the hollow-cylindrical wall 312. Passage openings 313 are located between these webs. The sealing element 311 and the hollow-cylindrical wall 321 are shown in the present case in such a manner that these two components overlap. In reality however, the sealing element 311 and/or the wall are correspondingly deformed. This applies to all the diagrams of all the embodiments.

In the illustration according to FIG. 3 the outlet valve 30 is closed. The sealing element 311 rests on the inner surface 323 of the hollow-cylindrical wall 321 of the valve body 32. By this means the interior of the infusion container 20 is sealed with respect to its surroundings. An inner surface 315 of the hollow-cylindrical wall 312 of the closure 31 rests on the outer surface 322 of the hollow-cylindrical wall 321. As a result of the abutment of these two surfaces or walls onto one another, the closure 31 is guided on the valve body 32.

FIG. 3 additionally shows the filter sieve 213 which is arranged at the dispensing opening 212. All the liquid which emerges through the outlet opening 212 must first pass through the filter sieve 213.

The dispensing opening 212 is closed by the outlet valve 30.

FIG. 4 shows the detailed view from FIG. 3 with open outlet valve 30. As can be seen from the diagram according to FIG. 4, the closure 31 was moved in the axial direction along the axis L (see on this matter FIG. 1). In this case, the sealing element 311 was pulled from the inner surface 323 so that a substantially annular gap is formed between the sealing element 311 and the hollow-cylindrical wall 321 of the valve body 32, through which the infusion liquid can be dispensed from the infusion container. The infusion beverage subsequently flows through the passage openings 313 and emerges at the lower end of the outlet valve in this diagram, i.e. at an outlet opening, from the outlet valve.

For movement of the closure 31 relative to the valve body along the axial direction from the first position (see FIG. 3) into the depicted second position, this was pulled with a suitable device, for example, a clip in the corresponding direction.

FIG. 5 shows an alternative inlet valve 30 in a diagram according to FIG. 3. The outlet valve 30 has a closure 31 and a valve body 32. The valve body 32 is in the present case configured as an integral component of the base part 21. The valve body 32 has a hollow-cylindrical wall 321 which extends away from the base part 21. In other words, the hollow-cylindrical wall 321 extends in the flow direction. This hollow-cylindrical wall 321 has an inner surface 323 and an outer surface 322. A thread not designated in detail is formed on the outer surface 323 as an integral component of the hollow-cylindrical wall 321.

The closure 31 has a hollow-cylindrical wall 312 and a sealing element 311 arranged centrally to this wall 312. The sealing element 311 is an integral component of a cap 316 which is connected to the hollow-cylindrical wall 312 by webs 317. Passage openings 313 are located between these webs. The hollow-cylindrical wall 312 has an inner surface 315 and an outer surface not designated in detail. A thread not designated in detail is formed on the inner surface 315 as an integral component of the hollow-cylindrical wall 312. This thread engages with the thread of the valve body 32. Teeth are formed on the outer surface of the hollow-cylindrical wall 312 so that the outer surface takes the form of a gear wheel and forms a toothed structure. Via this gear wheel, the closure 31 can be moved by means of a suitable means, in the present case, for example, also a gear wheel. As a result, the closure 31 can be moved with the thread in the axial direction from a first position depicted here into a second position depicted in FIG. 6.

The arrangement of the sealing element 311 on the inner surface 323 and the arrangement of the filter sieve 213 and the dispensing opening 212 corresponds to those arrangements which were described with reference to FIGS. 3 and 4. Accordingly reference is made to the text passages pertaining to these figures.

FIG. 6 shows the detailed view from FIG. 5 with open outlet valve 30. As can be seen from the diagram according to FIG. 6, the closure 31 was moved in the axial direction along the axis L (see on this matter FIG. 1). In this case, the sealing element 311 was pulled from the inner surface 323 so that a substantially annular gap is formed between the sealing element 311 and the hollow-cylindrical wall 321 of the valve body 32 through which the infusion beverage can be dispensed from the infusion container. The infusion beverage flows subsequently through the passage openings 313.

For opening the outlet valve, the closure was turned with a gear wheel not depicted here, which engages with the toothed structure of the closure and moved accordingly on the thread. As a result of the turning on the thread the closure 31 was thus moved in the axial direction.

FIG. 7 shows an alternative outlet valve in a diagram according to FIG. 3. The outlet valve 30 has a closure 31 and a valve body 32. The valve body 32 has a hollow-cylindrical wall 321. The valve body 32 is arranged overall inside a filter sieve 213 and in the present case set back into the interior of the infusion container in relation to a base part 21 of the infusion container 20. The filter sieve 213 encloses a dispensing opening 212. A closure 31 which in the present case is configured to be elastic is arranged in the dispensing opening 212. The closure 31 overall has a tube-shaped configuration with a hollow-cylindrical wall 312 and is everted in half. The closure 31 has a downwardly directed end in the present FIG. 7 which is closed by a membrane in which material thin points 314 are arranged. This end forms the outlet opening.

In the area of the eversion the closure 31 lies with an inner surface 315 of the hollow-cylindrical wall 312 on an outer surface 322 of the hollow-cylindrical wall 321 of the valve body 32. As a result of this eversion, the sealing element 311 is provided which rests on the outer surface 322 of the hollow-cylindrical wall 321. As a result, the interior of the infusion container 20 is isolated from its surroundings. The dispensing opening 212 is therefore closed.

FIG. 8 shows a detailed view of the outlet valve 30 from FIG. 7 with the outlet valve 30 in an open diagram. In order to open the outlet valve 30, i.e. to move it from the first position shown in FIG. 7 relative to the valve body 32 into the position shown in this figure, a pressure was applied inside the infusion container 20. The elastic closure 31 is deformed by this pressure so that the end of the closure 31 moves in the flow direction and releases a substantially annular gap between the hollow-cylindrical wall 321 of the valve body 32 and the inner surface 315 of the hollow-cylindrical wall 312 of the closure 31. As a result of a further build-up of pressure inside the infusion container, the thin points 314 can be broken open so that the infusion beverage can flow out of the infusion container 20.

As a result of a pre-tensioning of the closure 31 this springs back into its original position after the drop in pressure inside the infusion container 20 and thus closes the infusion container again. Subsequent dripping of the infusion container can thus be prevented.

FIG. 9 shows a perspective sectional view of an infusion container 20 with an alternative outlet valve 30. The infusion container 20 is configured substantially similarly to the infusion container 30 from FIG. 1. The infusion container itself comprises a base part 21 on which a closure 31 of the outlet valve 30 is arranged. The closure 31 completely spans the base part 21. A closure body 32 is formed centrally and as an integral component of the base part 21. A wall extending in the direction of the lid part 22 (see also FIG. 1) is provided on the base part 21 on the periphery thereof (see also FIG. 1). Also illustrated is a filter sieve 213 which is arranged upstream of a dispensing opening 212.

FIG. 10 shows a detailed view from FIG. 9. The central part of the outlet valve 30 is shown. The outlet valve 30 has a closure 31 and a valve body 32. The valve body 32 has a first hollow-cylindrical wall 321 and a second hollow-cylindrical wall 321′. The first hollow-cylindrical wall 321 and the second hollow-cylindrical wall 321′ are arranged substantially concentrically to one another. A hollow-cylindrical wall 312 of the closure 31 is arranged between these two walls 321 and 321′. The hollow-cylindrical wall 312 of the closure 31 has an inner surface 315 which is in contact with a corresponding outer surface 322 of the hollow-cylindrical wall 321. A sealing element 311 is arranged between these two surfaces. The hollow-cylindrical wall 312 also has an outer surface not designated in detail which is in contact with a corresponding inner surface of the second hollow-cylindrical wall 321′ of the valve body 32. A further sealing element 311′ is arranged between these two walls. Through the sealing elements 311 and 311′ the closure 31 is sealed with respect to the valve body 32 and therefore an interior of the infusion container 20 with respect to its surroundings.

FIG. 11 shows a further detailed view from FIG. 9 wherein the peripheral elements of the closure 30 are illustrated in this diagram. As already explained, the closure 31 spans the base part 21 as far as its periphery. Accordingly a wall extending in the direction of the inlet valve (see on this matter FIG. 1) is located on the periphery of the closure 31. A projection 319 is formed on this wall which engages in a corresponding recess of the wall of the base part 21. A shoulder 216 is additionally arranged in this recess. As can be seen from FIG. 11, the projection 319 and the shoulder 216 are arranged at a distance from one another in such a manner that a movement of the closure 31 in an axial direction is possible. In order to move the closure 31 in the axial direction, a notch 318 is provided on its circumference, into which a corresponding actuating mechanism, for example a device for brewing tea, can engage.

FIG. 12 shows the view according to FIG. 11 with open outlet valve 30. In order to open the outlet valve 30, the closure 31 was moved in an axial direction until the projection 316 of the closure 31 comes in contact with the shoulder 216 of the base part 21. The closure 31 has therefore experienced a defined axial displacement.

Accordingly FIG. 13 shows the view according to FIG. 10 with open outlet valve 30. The central part of the closure 31 was also moved axially by the axial movement described in FIG. 12. The hollow-cylindrical wall 312 was accordingly displaced axially along the wall 321′ and the wall 321. As can be seen from FIG. 13, in this position the sealing element 311 is out of engagement with the hollow-cylindrical wall 312 of the closure but the sealing element 311′ is as before in contact with the second hollow-cylindrical wall 321′ of the valve body 32. In other words, a substantially annular passage opening through which the infusion beverage can flow out is only created in the region of the sealing element 311.

FIG. 14 shows a detailed view of an alternative embodiment of the outlet valve 30 according to FIG. 9. In contrast to the embodiment from FIG. 9 no notch is provided on the periphery of the closure 31 but a toothed structure. The toothed structure is arranged on a wall extending in the direction of the inlet valve (see on this matter FIG. 1). This wall has a thread on its inner side which engages with a corresponding thread on the periphery of the base part 21. The outlet valve 30 is then opened similarly to the outlet valve 30 according to the exemplary embodiment from FIGS. 5 and 6. The seal between an interior of the infusion container 20 and its surroundings is formed similarly to the exemplary embodiment according to FIGS. 9 to 13.

It is understood that in all the presently described embodiment and/or methods, the infusion beverage has stayed inside the expanded infusion container 20 for a predetermined time interval before the outlet valve 30 is opened in each case.

1-13. (canceled)

14. An outlet valve (30) for an infusion container (20) for receiving a dried infusion substance, wherein the outlet valve (30) has a valve body (32) and a closure (31), wherein the closure (31) is movable relative to the valve body (32) in an axial direction from a first position into a second position.

15. The outlet valve (30) according to claim 14, wherein a sealing element (311), in particular a sealing lip, is arranged on the closure (31) for sealing between the valve body (32) and the closure (31).

16. The outlet valve (30) according to claim 14, wherein the valve body (32) has a hollow-cylindrical wall (321) and a sealing element (311) is arranged inside the wall (321) and in the first position of the closure (31) abuts against an inner surface (323) of the wall (321).

17. The outlet valve (30) according to claim 16, wherein the closure (31) has a hollow-cylindrical wall (312) which abuts against an outer surface (322) of the wall (321) of the valve body (32) for guidance of the closure (31).

18. The outlet valve (30) according to claim 17, wherein a thread is arranged on the hollow-cylindrical wall (312) of the closure which is in engagement with a thread on the outer surface (322) of the wall (321) of the valve body (32).

19. The outlet valve (30) according to claim 17, wherein passage openings (313) are arranged on the closure (31) between the sealing element (311) and the hollow-cylindrical wall (312).

20. The outlet valve (30) according to claim 14, wherein the valve body (32) has a hollow-cylindrical wall (321) and a sealing element (311) in the first position of the closure (31) abuts against an outer surface (322) of the wall (321), wherein in particular the closure (31) is configured to be elastically deformable.

21. The outlet valve (30) according to claim 20, wherein material thin points (314) are arranged on the closure (31) which provide passage openings (313) after being broken open.

22. An infusion container (20) for receiving a dried infusion substance for preparation of an infusion beverage, comprising a base part (21), a lid part (22) and a wall part (23) connecting the base part (21) and the lid part (22) and an outlet valve (30) according to claim 14, wherein the outlet valve (30) is formed in the base part (22).

23. The infusion container (20) according to claim 22, wherein the infusion container (20) is expandable, wherein in particular the wall part (23) has a variable length.

24. The infusion container (20) according to claim 22, wherein the valve body (32) is configured as an integral component of the base part (21).

25. The infusion container (20) according to claim 22, wherein a filter sieve (213) is arranged at a dispensing opening (212) of the infusion container (20) and the hollow-cylindrical wall (321) is configured following the filter sieve (213).

26. The infusion container (20) according to claim 22, wherein a filter sieve (213) is arranged at a dispensing opening (212) of the infusion container (20) and the hollow-cylindrical wall (321) is configured inside the filter sieve (213).
